(19) United States
(12) Patent Application Publication
(10) Pub. No.: US 2009/0117837 A1
(43) Pub. Date: May 7, 2009

(54) CMP PAD AND METHOD FOR MANUFACTURING THE SAME

(76) Inventor: Jae-Young Choi, Yongin-si (KR)

Correspondence Address: SHERR & VAUGHN, PLLC, 620 HERNDON PARKWAY, SUITE 200, HERNDON, VA, 20170, US

(21) Appl. No.: 12/265,853

(22) Filed: Nov. 6, 2008

(30) Foreign Application Priority Data
Nov. 6, 2007 (KR) 10-2007-0112545

(51) Int. Cl. B24D 3/28; B24D 11/00; B24D 18/00; B24D 3/34; B29C 43/04; B29C 35/08

(52) U.S. Cl. 451/527; 51/298; 264/319; 264/331.11

(57) ABSTRACT

Embodiments relate to a chemical mechanical polishing (CMP) pad. According to embodiments, a CMP pad may include a pad body having a series of concave and convex patterns and a chemical reactant formed on and/or over the pad body. The CMP pad may uniformly perform a CMP process without using abrasive grains. Accordingly, scratches on a surface of a wafer may be prevented.

The present application claims priority under 35 U.S.C. 119 to Korean Patent Application No. 10-2007-0112545 (filed on Nov. 6, 2007), which is hereby incorporated by reference in its entirety.

### BACKGROUND

A chemical mechanical polishing (CMP) process may be performed to process a surface of a wafer. A CMP process may allow a wafer to move relative to a body of a polymer pad including polyurethane while providing a chemical solution and slurry having abrasive grains between the body of the polymer pad and the wafer. Properties of a slurry and a body of a polymer pad may influence a CMP process. A CMP pad may directly contact the wafer, so a polishing rate, polishing uniformity, and a defect rate may vary depending on a surface state of the pad body. For a back end of line (BEOL) process, devices may be fabricated by using copper (Cu) and low-K materials, which may result in devices that may have rapid response characteristics. However, as shown in example FIG. 2, copper and low-K materials may be easily scratched due to their physical properties. A scratch may be caused by abrasive grains that may be contained in a slurry. Thus, an amount of scratching may be reduced if a CMP process is performed without using abrasive grains.

According to a related art copper (Cu) CMP mechanism, various chemical substances, such as an oxidizing agent, abrasive grains, chelate, may be contained in a slurry. A Cu surface may be oxidized by an oxidizing agent, and may be chemically and mechanically polished by the abrasive grains. However, according to the related art, scratches may be frequently generated by the abrasive grains that may be contained in the slurry.

### SUMMARY

Embodiments relate to a chemical mechanical polishing (CMP) pad and a method for manufacturing the same. Embodiments may provide a CMP pad and a method for manufacturing the same, that may be capable of reducing scratches during a CMP process. This may allow a pad body to have a substantially uniform configuration.

According to embodiments, a CMP pad may include at least one of the following: a pad body; and a chemical reactant formed on and/or over the pad body.

According to embodiments, a method for manufacturing a CMP pad may include at least one of the following: preparing a resin compound including a monomer and a curing initiator to form a pad body; and then mixing the resin compound with a chemical reactant that may chemically react with a polishing target; and then curing the resin compound to form the pad body.

According to embodiments, a CMP process may be performed using a chemical reaction of a chemical reactant and may not use abrasive grains that may cause scratches. Hence scratching may be avoided. According to embodiments, a surface of a CMP pad may have a uniform configuration, so that polishing may be uniformly performed on and/or over an entire surface of a wafer.

### DRAWINGS

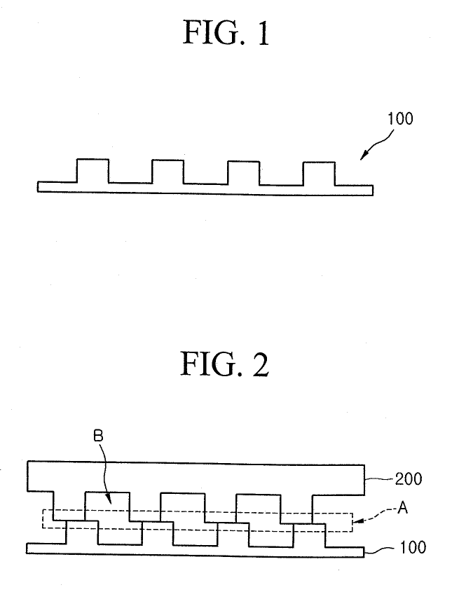

Example FIG. 1 is a drawing illustrating a CMP pad, according to embodiments.

Example FIG. 2 is a drawing illustrating a CMP process using a CMP pad, according to embodiments.

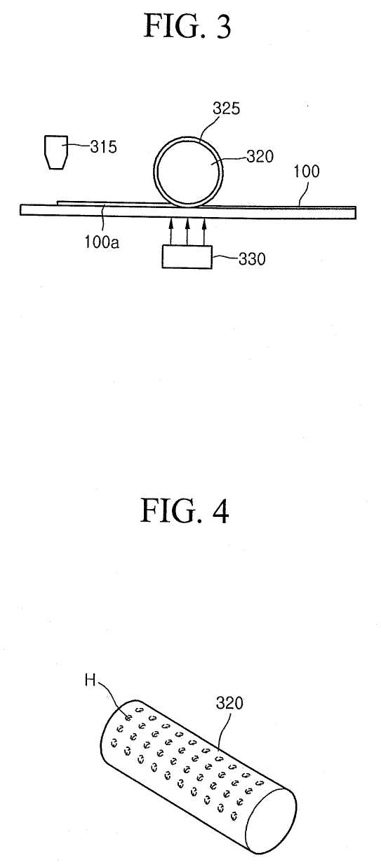

Example FIG. 3 is a schematic drawing illustrating a method for manufacturing a CMP pad, according to embodiments.

Example FIG. 4 is a schematic perspective drawing illustrating a roller used for manufacturing a CMP pad, according to embodiments.

### DESCRIPTION

According to embodiments, copper (Cu) may be used as an example of a polishing target. According to embodiments, other polishing targets may be used. According to embodiments, a CMP pad may be capable of uniformly performing a CMP process without using abrasive grains.

Example FIG. 1 illustrates a CMP pad according to embodiments. According to embodiments, a CMP pad may include a pad body having a concave-convex pattern and a chemical reactant formed in the pad body. The pad body may be fabricated using photo curable resin or thermosetting resin. The chemical reactant may be dispersed in the pad body. According to embodiments, the chemical reactant may be uniformly dispersed in an inside and an outer surface of the pad body. According to embodiments, a chemical reactant may be sprayed onto a pad body and may be in the form of fine particles. The chemical reactant may include nitrogen-function compound. The nitrogen-function compound may include at least one of ammonium salt, amine-based chemicals, ammonium acetate, ammonium oxalate, ammonium formate, ammonium tartrate, ammonium lactate, ammonium tetrahydrate, amino benzotriazole, amino butyric acid, amino ethyl amino ethanol, and amino pyridine. The chemical reactant may be one of these materials or a mixture thereof The chemical reactant may contact a polishing target and may cause a chemical reaction. The chemical reactant may make contact with an oxide of a polishing target, which may generate a chemical reaction.

Example FIG. 2 is a schematic view illustrating a CMP process using a CMP pad, according to embodiments. Example FIG. 2 shows a polishing mechanism of CMP pad 100 including a reactant in a CMP process using CMP pad 100 according to embodiments. Referring to example FIG. 2, oxidized polishing target 200 may contact CMP pad 100, which may include a chemical reactant. Contact portion A may be subjected to a chemical reaction, and non-contact portion B may not be subjected to the chemical reaction. Polishing target 200 may be rapidly planarized. According to embodiments, a scratch may be prevented and/or avoided because CMP pad 100 may not use abrasive grains. A chemical reactant may include nitrogen-function compound. The nitrogen-function compound may include at least one of ammonium salt, amine-based chemicals, ammonium acetate, ammonium oxalate, ammonium formate, ammonium tartrate, ammonium lactate, ammonium tetrahydrate, amino benzotriazole, amino butyric acid, amino ethyl amino ethanol, and amino pyridine. A nitrogen-function compound may easily react with copper oxide. According to embodiments, CMP pad 100 may easily polish the copper oxide.

A method for manufacturing a CMP pad according to embodiments will be described with reference to example FIGS. 3 and 4. Example FIG. 3 is a schematic view illustrating a method for manufacturing a CMP pad according to embodiments. Example FIG. 4 is a schematic perspective view illustrating a roller used for manufacturing a CMP pad according to embodiments. CMP pad 100, which may include a chemical reactant, may be fabricated as described herein. CMP pad 100 may be prepared in various shapes having various cross-sections.

According to embodiments, a monomer may be mixed with a curing initiator. This may prepare a resin compound that may be used to form a pad body. The resin compound may be mixed with a chemical reactant. The monomer may include urethane, but may not be limited to urethane. A thermally curable initiator may be used when heat is utilized, and a photo curable initiator may be used when light is utilized. A chemical reactant that reacts with copper (Cu) may include nitrogen-function compound having a nitrogen function group. According to embodiments, the nitrogen-function compound may include at least one of ammonium salt, amine-based chemicals, ammonium acetate, ammonium oxalate, ammonium formate, ammonium tartrate, ammonium lactate, ammonium tetrahydrate, amino benzotriazole, amino butyric acid, amino ethyl amino ethanol, and amino pyridine.

A resin compound and chemical reactant 100a may be supplied to nozzle 315. Nozzle 315 may spray the mixture on and/or over a surface of the pad body and may form a desired pattern on and/or over the surface of the pad body. Mold plate 325, which may have a regular engraving pattern, may be fabricated through an etching process. A micro-shape pattern may be uniformly formed in a large-size area through the etching process. Mold plate 325 may be fitted around roller 320 that may fix the mold plate 325 using a vacuum, as illustrated in example FIG. 3. At least one of heat and light may be supplied to roller 320 through a heat generator or a light generator 330 to press-mold the mixture. This may result in CMP pad 100 having a desired shape. The uppermost surface of CMP pad 100 may have a series of concave and convex patterns. Roller 320 may be formed with a plurality of holes H to fix mold plate 325 by using a vacuum, such as a vacuum chuck. A CMP process may be performed by inducing a chemical reaction using a chemical reactant without using abrasive grains that may cause scratches. Hence, scratches may not be generated during a CMP process. A surface of a CMP pad may have a uniform configuration. Hence, a whole area of a wafer may be uniformly polished.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A device comprising:
a pad body; and
a chemical reactant on the pad body.

2. The device of claim 1, wherein the pad body comprises a series of concave and convex patterns.

3. The device of claim 2, wherein the concave and convex patterns are formed using a mold plate with a prescribed engraving pattern to press-mold the pad body and the chemical reactant, and curing by providing at least one of heat and light.

4. The device of claim 1, wherein the chemical reactant is configured to chemically react with a polishing target.

5. The device of claim 4, wherein the chemical reactant selectively reacts with a contact portion of the polishing target when the polishing target is oxidized.

6. The device of claim 5, wherein the chemical reactant is substantially without abrasive grains.

7. The device of claim 1, wherein the chemical reactant comprises a nitrogen-function compound.

8. The device of claim 7, wherein the nitrogen-function compound comprises at least one of ammonium salt, amine-based chemicals, ammonium acetate, ammonium oxalate, ammonium formate, ammonium tartrate, ammonium lactate, ammonium tetrahydrate, amino benzotriazole, amino butyric acid, amino ethyl amino ethanol, and amino pyridine.

9. The device of claim 1, wherein the pad comprises a resin compound.

10. The device of claim 9, wherein the resin compound comprises a monomer and a curing initiator.

11. The device of claim 10, wherein the curing initiator comprises at least one of a thermally curable initiator and a photo curable initiator.

12. A method comprising:
preparing a resin compound for a pad body; and then
mixing the resin compound with a chemical reactant configured to chemically react with a polishing target; and then
curing the resin compound to form the pad body.

13. The method of claim 12, wherein curing the resin compound comprises:
pressing the resin compound mixed with the chemical reactant using a roller formed with a series of concave and convex patterns; and
curing the resin compound with at least one of heat and light.

14. The method of claim 12, wherein the resin compound comprises a monomer and a curing initiator.

15. The method of claim 14, wherein the resin compound comprises at least one of a thermally curable resin and a photo curable resin.

16. The method of claim 12, wherein the chemical reactant is substantially free of abrasive grains.

17. The method of claim 12, comprising selectively reacting the chemical reactant with a contact portion of the polishing target.

18. The method of claim 17, further comprising selectively reacting the chemical reactant with the contact portion of the polishing target when the polishing target is oxidized.

19. The method of claim 12, wherein the chemical reactant comprises a nitrogen-function compound.

20. The method of claim 19, wherein the nitrogen-function compound comprises at least one of ammonium salt, amine-based chemicals, ammonium acetate, ammonium oxalate, ammonium formate, ammonium tartrate, ammonium lactate, ammonium tetrahydrate, amino benzotriazole, amino butyric acid, amino ethyl amino ethanol, and amino pyridine.
